(19) United States
(12) Patent Application Publication
(10) Pub. No.: US 2013/0273517 A1
(43) Pub. Date: Oct. 17, 2013

(54) ON-LINE INTEGRATION AND CREDIT-GRANTING PLATFORM FOR LEARNERS SEEKING AND ENGAGING IN PRACTICE-BASED LEARNING IN THE REAL WORLD

(71) Applicant: Suzanne LETTRICK, San Anselmo, CA (US)

(72) Inventor: Suzanne LETTRICK, San Anselmo, CA (US)

(21) Appl. No.: 13/830,828

(22) Filed: Mar. 14, 2013

Related U.S. Application Data
(60) Provisional application No. 61/623,435, filed on Apr. 12, 2012.

(51) Int. Cl. G09B 7/00

(52) U.S. Cl. CPC G09B 7/00
USPC 434/362

(57) ABSTRACT

An integration system is provided for finding, enabling, and documenting completion of practice-based, real world experiences. One kind of collaboration system is an educational platform for providing learner-centric, real-world learning experiences, and supervising, evaluating, and granting institution credit for such learning experiences. A registry allows real world subject matter experts to offer supervision of real-world learning experiences and for learners to search for practice-based learning opportunities and to contact the associated supervisor to establish a learning experience in conjunction with an institution offering credit. A collaboration platform may provide targeted communications among learner, supervisor, and institutional representative (e.g. teacher) for establishing requirements of completion, tracking progress, gathering evidence of completion, and evaluating the quality of the evidence per each identified learner. The system may also comprise an accreditation module for translating a point score into a grade and/or an amount of institutional credit to be awarded to the learner.

### CROSS REFERENCE TO RELATED APPLICATIONS

This application claims priority to provisional U.S. patent application Ser. No. 61/623,435, filed Apr. 12, 2012, the entirety of which is incorporated by this reference herein.

### BACKGROUND OF THE INVENTION

1. Field of the Invention

The invention relates to practice-based forms of learning. More particularly, the invention concerns a scalable solution for individualizing, integrating, and documenting practice-based learning experiences in a real-word setting for receiving institutional credit across multiple regions of the world.

2. Description of the Related Art

Many different forms of practice-based learning are in use today. Practice-based learning may be performed outside of a classroom and independent of any formal educational institution. Examples of practice-based forms of learning include internships, apprenticeships, on-the-job training, working experience with credentials obtained in a foreign country, foreign language acquisition through immersion, independent study projects, gap year, volunteering, scouting, Model UN, and Junior Achievement. Practice-based forms of learning provide hands-on experience in the real world.

Although many opportunities for practice-based forms of learning are not associated with any educational institution, an educational institution may grant credit towards a certificate or degree for learning that takes place in a classroom on the same or similar topic or subject area. For example, an institution may give a learner credit for completing a class that teaches a foreign language, but the credit appears to be granted based on enrollment in such a class, attendance, and fulfilling requirements of the class rather than on the acquisition of the foreign language the class purports to teach. Although practice-based learning provides a practical component to balance the theory taught in the classroom and helps burgeon 21st century skills, such as collaboration, leadership, communication, and problem solving skills within learners, most educational institutions (of all levels) currently do not have the infrastructure in place to evaluate experiences obtained in the real world so as to be able to grant credit for such experiences towards a certificate, college degree, or high school exit requirements. For example, a high school student who has taken private piano lessons for many years and sung in her church choir may be denied graduation from high school for lack of required credits in fine arts, since the classes were not taken within the walls of the credit-granting institution. Another example is that high school students are generally not able to obtain Physical Education credit required for graduation by demonstrating extra-curricular participation in little league/intramural sports, martial arts, gymnastics, ice skating, etc. A medical professional (e.g. doctor or nurse) with many years of experience outside of the U.S. may be prevented from practicing medicine in the U.S. for lack of a U.S. issued certification, and may not have the resources to start medical education completely over again in a U.S. educational institution. There's no mechanism to grant credit towards U.S. certification based on knowledge and skills gained from the previous medical practice. Or a law student might lack the real world experience necessary to do good work in the real world of law even after passing the bar exam due to hands-on, experiential forms of learning not currently being required, included, or available as a consistent and accountable part of the student's law school education.

Past attempts to grant credit for real-world experiential learning have been ad hoc and specific to a particular student (e.g. independent study project), an educational institution (e.g. school-sponsored study abroad or vocational internship), region or subject area (e.g. English composition writing skills assessment for incoming college freshman). A problem with this approach is:
Custom independent study projects specific to individual students do not scale well because they are ad hoc and lacking in infrastructure support. A teacher rarely has time or logistical scaffolding to create/oversee an individual learning experience for many students concurrently. Ad hoc approaches may only work when a small portion of learners are involved.
Granting credit for experiences that are only associated with a particular educational institution may result in difficulty transferring credits to another institution for lack of standardization. An ad hoc approach makes standardization difficult. An institution granting credit for real-world experience without standardization may result in a loss of accreditation. To promulgate wide-spread adoption of such learning experiences, accreditation agencies would need to be able to evaluate the granting of college credit across institutions.
Offering credit for experiences in only a limited number of subjects or regions may result in only a small segment of the learning population that may benefit from a practice-based learning experience.

Many of the examples of practice-based learning that exist today, such as independent study or study abroad, are examples of an educational institution offering such an experience as part of the curriculum. Administering granting credit for learning that has taken place outside of the context of any institution may be even more problematic.

### SUMMARY OF THE INVENTION

A mechanism is provided that allows a person to demonstrate knowledge or skills acquired by practicing that knowledge and those skills in a real world setting and is able to grant credit for that knowledge or those skills towards a degree/certificate/credential. Using such a mechanism, one college/university (or hundreds) may be enabled to grant credit towards a business degree based on participation in a Junior Achievement program or credits for government classes based on working as a congressional intern or page prior to attending the institution. Or a law school might be able to bestow credits to a law student for engagement in a law apprenticeship, internship, or other form of hands-on or experiential effort in the legal field. Similarly, vocational schools and/or community colleges may offer credit towards a certificate in baking and catering based on a part-time job in a bakery or a certificate in automotive repair based on experience helping one's relative restore an antique car.

The disclosed mechanism supports a scalable, standards-based, unifying approach to granting credit for a wide-variety of practice-based learning, yet is flexible for use in different regions of the world.

The approach described herein provides a digital, internet-based mechanism for schools and universities (and other institutions) to open up their walls so learners can participate in, collaborate with other students and real world experts in an integrative way, and/or gain credit from practice-based forms of learning in the real world. An online platform provides an elegant, user friendly, flexible, automated, generative, and reliable mechanism for schools and universities to offer current or prospective students academic credits for completing real world practice-based forms of learning in alignment with individualized rubrics (i.e., academic standards, project goals, teacher's/supervisor's guidelines, desired work skills, or scout badge requirements).

Often there is a gap between the theoretical knowledge students acquire in a school setting and the practical knowledge they must have to engage and work in the real world once they graduate from an educational institution. Similarly, some students are better able to learn by doing rather than by studying a book, listening to lectures, and taking tests. The approach described herein puts the ownership (development) of the learning experience into the hands of the learner and accommodates a larger variety of learning styles and needs.

A platform is provided that supports practice-based forms of learning in the real world with documented learner results that are fed back to any participating institutional setting. Components of the platform support searching for and customizing practice-based learning opportunities in the real world, customizing and/or standardizing requirements, demonstrating completion, mentoring and evaluating performance, and administering credit. The platform may be used to showcase the demonstrable learning/skill required based on standard forms of proof: performing a task, researching a topic, writing a publishable article, developing and implementing a new strategy, or accomplishing a real-world goal (e.g. starting a new business, solving a social problem, inventing a new product, etc.). A participating institution may create a rubric to map the evaluation of these forms of proof to specific class credit.

### BRIEF DESCRIPTION OF THE DRAWINGS

FIG. 1 is a block diagram of components comprising an online integration platform, according to an embodiment of the invention.

FIG. 2 is a block diagram of components comprising a collaboration support module, according to an embodiment of the invention.

FIG. 3 is a flowchart depicting the high level workflow steps supported by the online integration platform, according to an embodiment of the invention.

FIG. 4 is a block schematic diagram of a machine, according to an embodiment of the invention.

### DETAILED DESCRIPTION

The nature, objectives, and advantages of the invention will become more apparent to those skilled in the art after considering the following detailed description in connection with the accompanying drawings.

Practice-based learning has many advantages over classroom or online learning. Success in a classroom may favor visual or auditory learners. Practice-based learning may allow learning through means not available in a classroom or strictly online settings, and thus better accommodate students with different learning styles (e.g. kinesthetic learners). Practice-based learning may also help to reinforce or deepen understanding of academic instruction and may be a valuable component or adjunct to classroom or online instruction. As mentioned before, practice-based immersive learning may also help to burgeon previously latent skills within learners, such as leadership, problem solving, teamwork, or communication skills. Such skills are transferable and required—yet currently found lacking in youth—in the real world of work post graduation.

Also, practice-based educational experience can be more engaging, relevant and practical for the learner, and can relieve students from being required to take classes (e.g. pre-requisites or general education classes) that teach information that is redundant in view of life experiences. Giving credit for knowledge or skills previously acquired from hands-on, real-world experience may allow a student to spend more time studying the core or advanced classes in the chosen major or degree program. As a result, more students could be accommodated without significantly increasing expenditures.

In addition, many institutions of higher learning are experiencing serious budget issues, having to lay off professors/teachers, cut the number of classes offered, and reduce the number of students that can be enrolled. By validating a person's real world experience consistent with an institution's accreditation, the institution could charge for credits granted without having to provide the associated classroom time. Validation is much less expensive than education. Comparatively little resource is required to grant credits for validated learning. As a result, the institution could expand its scope and quality education by outsourcing certain experiential lessons to experts in the field that otherwise could not be utilized for the benefit of the institution and the students.

To obtain the benefits described herein, an infrastructure is needed to allow widespread deployment of granting credit for practice-based learning. An online integration platform is described herein to support scalability, accountability, and standardization for accrediting practice-based learning experiences.

### Exemplary Platform

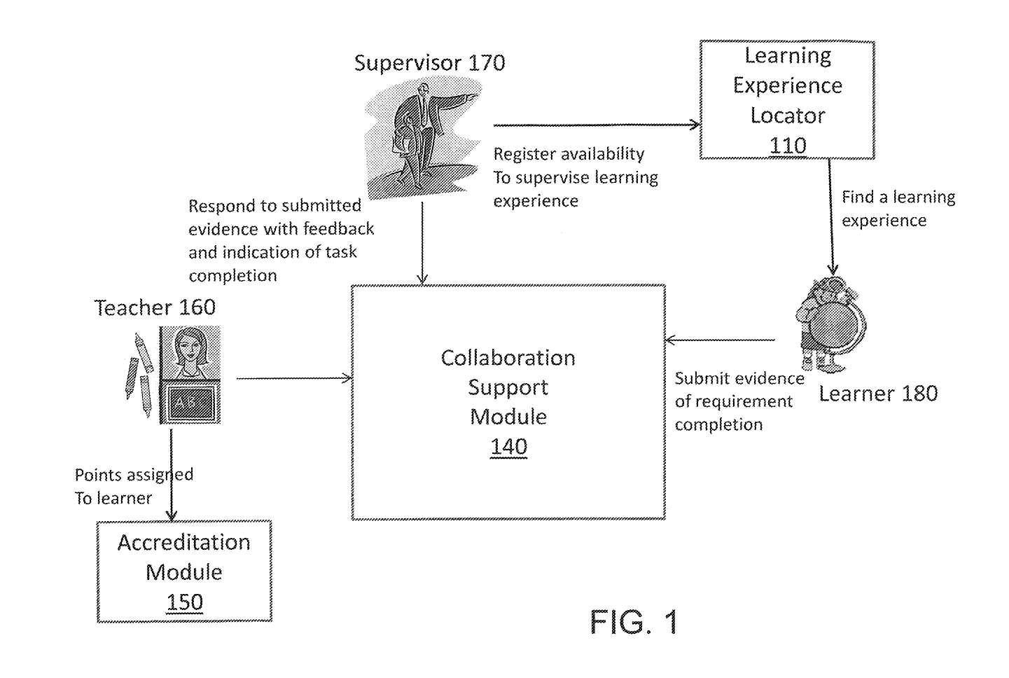

FIG. 1 is a block diagram of the components of an online integration platform, according to an embodiment of the invention. The components include an Experience Locator 110, a Collaboration Support Module 140, and an Accreditation Module 150. A description of each of these components is described below.

Learning Experience Locator 110: The Learning Experience Locator 110 provides a searchable directory of opportunities for practice-based forms of learning in different regions. Although a learner may identify a practice-based learning opportunity using the learning experience locator 110, the learner may identify or define opportunities in any way, such as through personal connections. The directory may be helpful for those learners who want to browse through opportunities and/or do not have the personal connections. The Real World Supervisor 170 (referred to as “supervisor” herein) is a person suited to offering a specific learning experience in the real world (outside the walls of the educational institution). The supervisor provides instructions, guidance, mentoring, feedback, and evaluation from a real-world perspective. Often, a supervisor may provide tools and workspace as well. An offer to supervise a real-world learning experience may be vetted and registered on behalf of supervisor 170 with the learning experience locator 110.

The learning experience locator 110 comprises a data store for storing registered opportunities, a user interface for receiving selection criteria, a query facility for retrieving opportunities from the data store that meet the selection criteria, and a display facility for displaying the matching opportunities. Selection criteria may include the topic (subject) of the learning experience such as jewelry making or art history, the location of the learning experience such as a country for foreign language study, and the medium of learning such as internship, apprenticeship, independent study project, vocational training class, part-time job, or community group such as scouting or Junior Achievement. In an embodiment of the invention, opportunities may be described and selected by specifying a learning style associated with the learning opportunity. For example, a learning experience that involves building something may appeal to a kinesthetic learner. Thus, a kinesthetic learner may search for learning opportunities that are described as appealing to a kinesthetic learner.

A learner 180 specifies through the locator's user interface search criteria that describe characteristics of a desired learning opportunity. Upon receiving the criteria, the learning experience locator may search the data store of registered learning experiences opportunities and present to learner 180 the experiences that match the specified criteria. Teacher 160 may also use the learning experience locator to find a real world learning experience for a learner. For example, a home school teacher (e.g. a parent) may identify an experience for the learning to pursue.

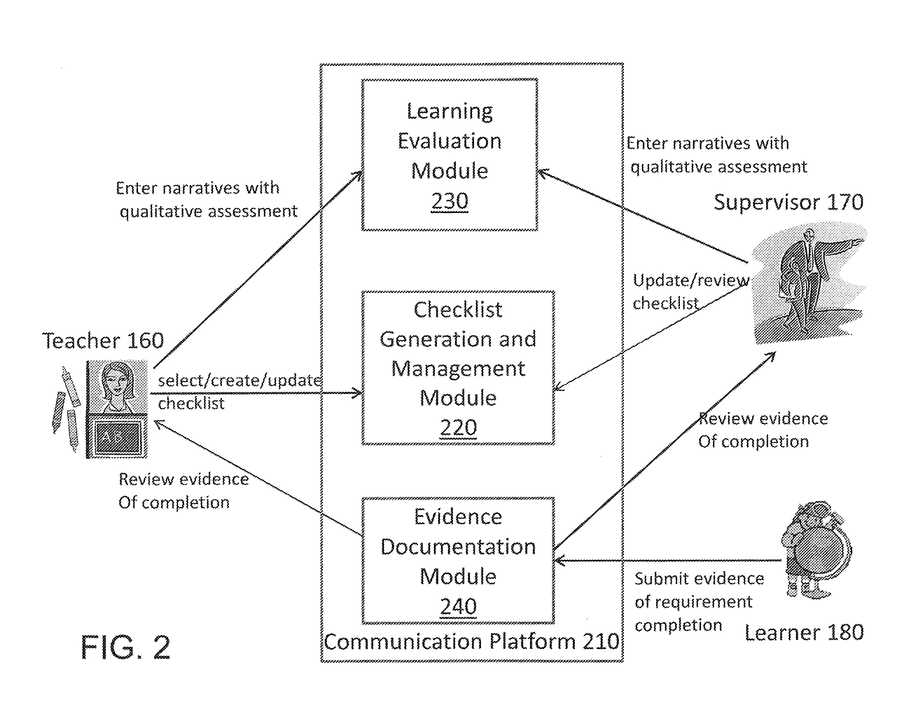

Collaboration Support Module 140: The collaboration support module 140 facilitates the communication among the learner 180, the supervisor 170, and the teacher 160. In addition to the teacher's role as educator, teacher 160 also represents all roles played by agents of the educational institution. FIG. 2 illustrates the components of the collaboration support module 140 and their interactions with the learner 180, supervisor 170, and teacher 160. The components of the collaboration support module 140 comprise a Communications Platform 210, Checklist Generation and Management Module 220, a Learning Evaluation Module 230, and an Evidence Documentation Module 240.

Communications Platform 210: The communications platform 210 provides infrastructure for integrating the various components of the collaboration support module. The infrastructure may be a completely new facility designed specifically to enable collaboration as described herein. In an embodiment, the communications platform 210 may support the Schools Interoperability Framework (SIF) that is an internet-based messaging protocol that allows school-related applications to interoperate. The communications platform 210 may allow components of the collaboration support module to communicate with other school-related applications, and/or may be used for communication among the components of the collaboration support module themselves. In an embodiment, the communications platform 210 may provide the ability to exchange information with existing teacher/student/parent communication platforms such as PowerSchool or Eschool, online learning platforms such as Khan Academy, assessment degree systems, such as University of Wisconsin's Flexible Option, or social networking platforms.

Checklist Generation and Management Module 220: The checklist generation and management module 220 provides the ability to define and store one or more checklists containing the institutional requirements for earning credit for a learning experience. Once a learning experience has been selected, teacher 160 may use the checklist generation and management module 220 to select a checklist that contains the list of evidence (standards, rubrics, competency lists, requirements) needed to be produced in order to complete the learning experience for institutional credit. A set of checklists may be chosen from among the nation's/world's most common checklists or stored from previous learning experiences and simply chosen for use in the current learning experience. Alternatively, teacher 160 may customize a full or partial checklist for a new learning experience. The checklist generation and management module 220 may store checklists for common core requirements, state requirements, and/or school requirements. Teacher 160 may start with a copy of a standard set of requirements and customize the checklist, or may cut and paste checklist items from a number of distinct pre-existing checklists and/or standards.

In addition to storing completion requirements, the checklist generation and management module may also store requirements of certifications awarded outside of the institution for the purpose of determining which checklist items of a real-world learning experience have already been satisfied and certified by a trusted third party entity. For example, there are documented requirements for being awarded a scouting badge. An institution trusting the integrity of the scouting program may give full or partial credit towards institutional credit for a learning experience in a corresponding subject area. For example, the checklist generation and management module 220 may support applying requirements for earning a drawing and painting scouting badge towards corresponding requirements for completion of an elementary level institutional art course. In another embodiment, if no institution representative is part of the learner's team, a checklist item may be considered completed when the supervisor alone signs his or her approval.

The checklist generation and management module 220 also allows teacher 160 and supervisor 170 to interact with a checklist that tracks the progress of the learner 180 towards completion of the learning for credit. Each checklist and checklist item may be associated with a state. Example states may comprise a set including one or more of {not started, started, in progress, evidence submitted, approved by supervisor, approved by teacher, or completed}. Each checklist item may be independently approved by teacher 160 and supervisor 170. In an embodiment, a checklist item may be considered completed when both teacher and supervisor sign their approval.

Learning Evaluation Module 230: At pre-determined times (as per chosen parameter inputs) the learning evaluation module may notify the teacher 160 and/or supervisor 170 by email or by other means of notification to complete a narrative form regarding the learner's progress as of that intermediate checkpoint prior to completion of the learning. The real world supervisor and/or the teacher may review and evaluate the evidence of completion submitted by the learner. The supervisor and/or teacher may write a narrative describing the learner's progress including a quantitative and qualitative evaluation of completing the checklist requirements. Progress may be quantitatively demonstrated by the set of checklist items completed and teacher/supervisor approved as of the intermediate checkpoint. In addition, qualitative assessment may be documented regarding the learner's behavior, attitude, cooperation, enthusiasm, initiative, interpersonal interactions, etc. Although not illustrated in FIG. 2, when the teacher and supervisor receive a prompt to fill out the narrative template, the learner may receive a rating request to rate the teacher and/or supervisor on several traits (i.e., content knowledge, mentorship, reliability, safety, attitude, etc.).

At the conclusion of the learning experience, the teacher may consider the evidence as well as narrative evaluations in determining a final point score to award the learning experience.

Evidence Documentation Module 240: The evidence documentation module 240 stores and organizes artifacts relevant to the learning experience that demonstrate and confirm that learning has taken place by the learner. The system may provide an authentication mechanism for the learner to authenticate the evidence as having been created and supplied to the system by the learner. An artifact is evidence that a learner has performed a task, demonstrated knowledge, or created something that might not be convenient to bring into a classroom. Some examples of evidence may include a photo essay of the learner painting a mural on an exterior building wall, a video recording of the learner speaking in a foreign language in a way that demonstrates what was learned in the context of the learning experience, the iterative written process of a law student's real world experience preparing a case for a local lawyer, or an audio recording of a learner interviewing a subject for a research project. Evidence might include a blog entry demonstrating steps in an innovative chemistry experiment, or online video demonstration of the proper application of math concepts to a baking project. Documentation of final assessments such as presentations, exhibits, recitals, portfolios, and even traditional tests/quizzes might also be housed in the documentation module. In addition, evidence provided for seeking physical education credit might include a certification not issued by the school, for example a PADI scuba diving certification, certificate of completion of a square dancing class, or a black belt in karate. Although written research papers, essays, and tests can also be included as evidence, the evidence documentation unit is able to accommodate many more kinds of evidence than those usually accepted or feasible in a classroom setting.

A learner 180 may submit evidence of completing a requirement by loading documented evidence of any kind of digitized medium such as video/film or audio recording, photograph, blog, photocopy, text document, braille, and media that does not yet exist at the time of this invention. Media may be captured/generated and uploaded into the system by a mobile device such as a smart phone, a video or still camera, tablet, laptop, or desktop computer, or any other source of media.

Supervisor 170 and teacher 160 may view the evidence before signing approval for each checklist item. Organizing all the evidence for a student with respect to a particular learning experience relieves the burden on the teacher for having to keep track of the artifacts. As mentioned before, this system can allow for more flexibility of learner options (i.e., time frame, geographic region, mode of expression, learning styles, and choice of subject). The burden for determining how to fulfill the checklist items may be placed on the learner. If needed, the teacher and/or supervisor may mentor the learner on ways to complete checklist items, empowering and encouraging a student to direct the real world learning experience. An artifact entered into the evidence documentation module 240 may be annotated by the learner to indicate the particular checklist item for which the artifact provides evidence of completion. Similarly through the mechanism, a teacher and supervisor may give iterative feedback/commentary on student's documented checklist artifacts.

Accreditation Module 150: Teacher 160 determines a total point score to award the learning experience based on the checklist completion and evaluative narratives, and enters the total point score into the accreditation module 150. The accreditation module 150 translates the point score to a grade and/or a number of credits according to previous configuration provided by the learning institution. For example, in the Santa Clara Unified School District in California, ten graduation credits are granted a student in an English class for satisfactorily completing one year of teacher-derived, point-awarded assignments. Four years of English credits(i.e., 40 credits) in total are required to graduate from high school in the Santa Clara School District.

In contrast, UC Berkeley (which many California schools set as the guidepost when determining their own graduation credit requirements) and UC Berkeley Extension use the standard formula of one unit of credit per 15 hours of instruction, plus two hours of study for each hour of instruction. Therefore, a one-unit course is a total of 45 hours of course effort.

Another example is San Francisco University High School where a full year of English [at UHS] yields two semester credits. One credit is awarded per [semester] class, and all courses at SF University High School are awarded equal academic credit (except where noted in the Course Catalogue).

In an embodiment, the accreditation module is shared by many educational institutions; however, each institution may have a different grading scale or offer different amounts of credit for the same learning experience. For example, one school might specify that any learning experience being assessed by the school earning a total of 80 points is assigned a “B” grade. Another school may specify that 80 points earns a “B minus” grade for all learning experiences being assessed by the other school. In addition, each institution may also configure the amount of credit to grant to the learner 180 based at least on the identified learning experience and the institutional points awarded.

In an embodiment, the relationship between checklists, points, grades, and credit is stored together across all educational institutions supported by the platform, facilitating the evaluation of schools by accrediting agencies and enabling comparison of requirements across schools. In an alternate embodiment, the accreditation module 150 may be managed for a single institution.

### Configuration

Table 1 (below) provides examples of the kinds of configuration information that need to be provided to customize the integration platform for the set of institutions that will be supported by the platform. In an embodiment, a selection of the most often used configuration may be pre-loaded into the platform, and configuration simply requires selecting which configurations to use for the deployment scope. For example, a set of often-used standards, rubrics, and checklists may be pre-loaded into the platform, but only those needed by the particular institutions sharing the platform may be selected for use. Similarly, a set of commonly used point-to-grade conversion modules may be built into the platform, and only the ones being used by institutions sharing the platform may be selected for use. In an embodiment, additional configuration choices such as point-to-grade conversion modules or standards may be plugged into the platform when the pre-loaded modules do not provide what is needed.

TABLE 1
Platform configuration information

| Checklist generation and | | |
|---|---|---|
| management module | Accreditation Module | Evaluation Module |
| Common core checklists | Point to grade conversion | Start and end dates |
| IB standards | | |
| Standards for other | | |
| regions | | |
| State requirement | Point to credit conversion | Evaluation intervals |
| checklists | | |
| Gap year standards | (Ex: Lang College: one | Narrative forms |
| | gap year = 30 college | |
| | credits) | |

The scalability and flexibility of the online integration platform requires that the platform be configured based on the diversity of institutions supported by a particular instance of the platform. Global configuration is configuration that applies to all institutions that are supported by the same particular instance of the platform. For example, a platform administered by a State Department of Education for institutions within the state may have state standards globally configured, and the point-to-grade conversion may be configured globally as part of the platform because the point-to-grade conversion may be the same for all institutions using the platform.

Local configuration is configuration that is specific to a particular institution, and applies to all learning experiences being assessed by the particular institution. For example, a platform hosted and administered by a third party service provider that serves institutions across states may have state standards configured locally for each institution, based on in which state each institution resides.

Some configuration is specific to an individual learning experience opportunity or an individual instance of a learning experience. For example, a particular learning experience opportunity may be associated with a common checklist, so that any learner engaging in the learning experience may be evaluated based on the same checklist, but the checklist may be different from the checklist for a different learning experience opportunity. However, each instance of a learning experience may have configured a unique combination of (teacher, supervisor, and learner).

### Exemplary Operating Sequence

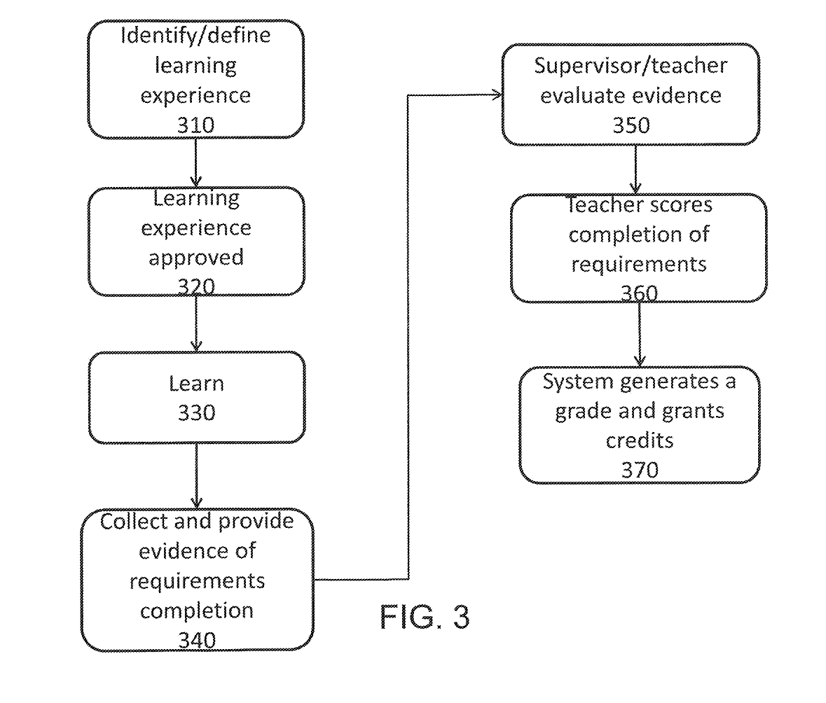

FIG. 3 is a flowchart depicting the high level workflow steps supported by the online integration platform, according to an embodiment of the invention. At Step 310, the learner or teacher identifies the desired learning experience. The learner or teacher may identify a learning experience without help, or the learner may use a learning experience locator to help find a supervisor willing to oversee a practice-based learning experience. The student may request approval for receiving institutional credit for the identified learning experience during this step as well.

In Step 320, the request is approved and a teacher (if not pre-identified at the input stage) is assigned to evaluate the work. For example, there may be a governing board (or a home-schooling parent) that approves the request. The teacher may independently approve or be assigned by the governing board after approval is obtained. In any case, before the learning experience begins, if the learning experience has not already been defined within the system, the teacher may create a checklist of measurable requirements that indicate how the learner will demonstrate that the learning has been accomplished such that institutional credit will be granted, or the teacher may use a checklist (set of standards) preapproved by the district that is already provided (e.g., via a scroll down menu) within the system.

In Step 330, the learner may interact with the supervisor in the real world (non-classroom or non-online) setting to learn as proposed and to produce evidence that checklist items are completed. As each requirement is satisfied, the learner may collect and provide evidence of requirements completion in Step 340. In addition to the instruction and coaching that the supervisor provides in Step 330, the supervisor and/or teacher may iteratively evaluate the quality of the evidence of requirement completion and determine whether (and the extent to which) the requirements have been met in Step 350. At various points throughout the learning process, the supervisor and/or teacher may provide a written narrative that is provided to the learner and other participants in the learning experience. In an embodiment, the various evaluation points are input by a participating party (i.e., learning institution) at set intervals relative to the amount of time provided for the learning experience to complete. In another embodiment, an intermediate evaluation checkpoint may be triggered by the completion of a major task at various points throughout the learning process In Step 360, at the conclusion of the learning experience, the teacher may evaluate the evidence, taking into consideration the supervisor's evaluation narratives, and may assign a point score to award the learning experience. In an embodiment, the point score may be a number from 1 to 100 (such as a percentage). However, any point scale may be used. The teacher may also write a narrative evaluation that is provided to the learner and/or supervisor. Based on the configuration of the accreditation module 150, the system may generate a grade and/or grant credits to the learner in Step 370.

In addition to evaluating the completion of the work, each participant (i.e., learners, teachers, real world supervisors) may be solicited to evaluate the learning process and provide an opinion regarding the contribution of the others associated with the learning experience. For example, the learner may be requested to evaluate the supervisor and teacher via a simple automated rating system within the platform itself, the supervisor may evaluate the learner and the teacher, and the teacher may evaluate the supervisor and the learner. Likewise, a learner may evaluate the real world supervisor on the supervisor's mentorship, reliability, safety, as well as on content knowledge or ability to transfer this information to a learner.

### An Example Machine Overview

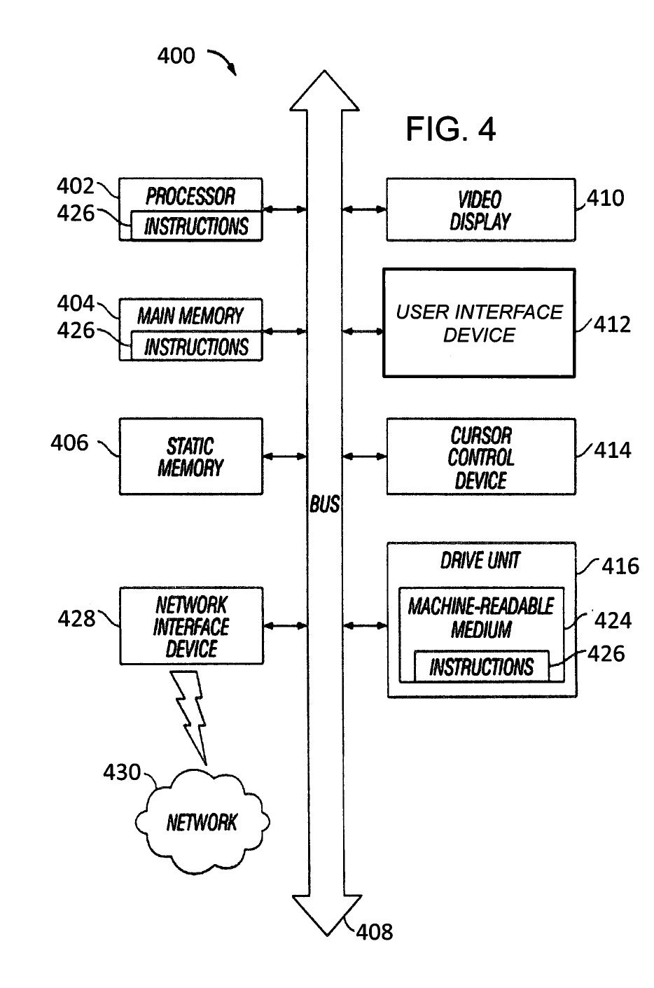

FIG. 4 is a block schematic diagram of a machine in the exemplary form of a computer system 400 within which a set of instructions may be programmed to cause the machine to execute the logic steps of the invention. In alternative embodiments, the machine may comprise a network router, a network switch, a network bridge, personal digital assistant (PDA), a cellular/smart telephone, a tablet computer, a Web appliance or any machine capable of executing a sequence of instructions that specify actions to be taken by that machine.

The computer system 400 includes a processor 402, a main memory 404 and a static memory 406, which communicate with each other via a bus 408. The computer system 400 may further include a display unit 410, for example, a liquid crystal display (LCD) or a cathode ray tube (CRT). The computer system 400 also includes a user interface device 412 which may comprise an alphanumeric input device, for example, a keyboard, a Braille reader/writer; a microphone/speaker, or a media input device receiving digitized media such as audio and video. The computer system 400 may also include a cursor control device 414, for example, a mouse; a disk drive unit 416, and a network interface device 420.

The disk drive unit 416 includes a machine-readable medium 424 on which is stored a set of executable instructions, i.e. software, 426 embodying any one, or all, of the methodologies described herein below. Alternatively, disk drive unit 416 may represent the use of cloud storage in which third party hosts store data in virtualized pools of storage in large data centers and provide data on demand over a network. The software 426 is also shown to reside, completely or at least partially, within the main memory 404 and/or within the processor 402. The software 426 may further be transmitted or received over a network 428, 430 by means of a network interface device 420.

In contrast to the system 400 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

### Other Embodiments

In an embodiment, a company may host the online integration platform and sell subscriptions for the use of the platform to institutions of learning. Institutions may include all K-12 public and private schools as well as home schools, community colleges, four-year colleges, vocational schools, and universities. They also may include knowledge-gathering institutions, such as research organizations, or alternative learning institutions, such as museums, libraries, or online learning institutions. The platform may operate with any institution on the planet. A single subscription may cover a single student being home-schooled or a university with thousands of learners.

Collaboration between learners associated with different institutions, each with its distinct subscription to a common platform, may be possible when the platform supports sharing of collaboration artifacts across subscriptions. For example, the checklist generation and management module may create a checklist of tasks that can be shared among researchers at institutions, each with their own subscription. Similarly, the evidence documentation module may store revisions of a research paper or other project artifacts that are accessible to the researchers at different institutions. The platform provides a user experience that is friendly to all institutions regardless of size. Alternatively, an entity such as an educational institution or government agency (e.g. the department of education) may deploy and operate an online integration platform only for the entity's own use or on behalf of other institutions represented by the entity. For example, a very large university with an IT department might own and operate the platform rather than subscribing to a third party service.

In an embodiment, the platform components may comprise a distributed system in which components interoperate but may be leased/owned and operated by independent entities. Different subsets of components (i.e. different combinations of components) of the platform may be hosted by the same entity. For example, the experience opportunity locator may be provided by separately from the other platform components. A company hosting the experience opportunity locator may offer a separate subscription or be funded by advertisements and offered to the learner for free. The checklist generation module and/or the accreditation module may be hosted by an accreditation agency and interact with the other platform components hosted by other entities. The platform may also interconnect with other educational systems such as PowerSchool, Eschool, homeschool access, or with other learning and/or collaboration mechanisms such as Google, iTunes, Google maps, Google docs, scientific paper writing platforms, and various other learning/research/documentation applications. Likewise a learner could use just a subset of the available components that are necessary to the learning goals at hand. For example, if awarding credit is not relevant, the accreditation module need not be used.

Although many of the examples provided above describe learning experiences that are pursued while registered with a learning institution, the platform can also be used for awarding credit for past, completed experiences. In that case, a real-world supervisor might not be needed, or may be relied on only to evaluate what was previously done as a consultant to the institution regarding the quality and/or completeness of the learning that can be used to determine the amount of credit to award.

Moreover, the learning process supported by the platform may be viewed more generally as a collaboration platform where learner, supervisor, and teacher collaborate towards a common goal. However, there are other contexts in which the same platform functionality may be used. For example, journalists, researchers, and scientists that are geographically dispersed and associated with different institutions could use the platform to collaborate on joint projects. In an embodiment, the learning experience locator could be used to locate other people with a common research interest for discussing ideas and potentially working together on a common project. In another embodiment, experts in the world (supervisors) can find schools who could use their expertise/support with a real world project via the platform. In an embodiment, the collaboration module can be used to document action items for each participant and enable the organization of evidence collected in support of completing an action item. In an embodiment, the checklist generation and management model may be configured with lists of best practices and/or life cycle descriptions in a particular subject area or professional discipline from which to construct an agreed-upon process.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

1. A system for granting institutional credit for practice-based learning experiences in a real-word setting comprising:
one or more communicatively coupled processors;
a learning experiences locator for registering and finding a practice-based learning experience opportunity for a particular topic, wherein each practice-based learning experience opportunity is associated with one or more supervisors who are knowledgeable about the particular topic;
a checklist generation and management module for selecting or generating a checklist of requirements for completing of a practice-based learning experience;
an evidence documentation module for receiving from a learner evidence of meeting one or more requirements on the checklist of requirements for completing of the practice-based learning experience, and organizing and storing the evidence;
an accreditation module for receiving a number of points assigned to a learner's completion of requirements on the checklist of requirements, and responsive to receiving the number of points assigned to the learner's completion of requirements on the checklist of requirements, generating a grade or a number of institutional credits to grant to the learner.

2. The system of claim 1, wherein a first student attending a first institution that awards a particular number of points based on completing the requirements specified by a particular checklist associated with a particular practice-based learning experience is granted a first number of credits; and
Wherein a second student attending a second institution that awards the same particular number of points based on completing the requirements specified by the particular checklist associated with the particular practice-based learning experience is granted a second number of credits, wherein the second number of credits is different from the first number of credits.

3. The system of claim 1, wherein the evidence documentation module stores evidence for at least 15 million learners.

4. The system of claim 1, wherein at least 40,000 institutions share a single instance of the system.

5. The system of claim 1, wherein the accreditation module stores point-to-credit or point-to-grade conversions for a plurality of institutions that are located in different states or nations.

6. The system of claim 1, wherein the checklist generation and management module stores checklists for a plurality of distinct learning experiences; and
wherein learners associated with the plurality of distinct learning experiences engage in learning experiences while residing in a plurality of different countries.

7. The system of claim 1, wherein the checklist generation and management module stores checklists for a plurality of distinct learning experiences; and
a plurality of supervisors supervising the plurality of learning experiences reside on different continents.

8. The system of claim 1, wherein the evidence documentation module is operable to store evidence at least when classes at the institution are not in session.

9. The system of claim 1, wherein the checklist generation and management module provides for selecting a checklist from a plurality of pre-loaded checklists associated with learning experiences on a plurality of topics; and
wherein a common core educational standard or a state standard is included in the plurality of pre-loaded checklists.

10. The system of claim 1, wherein the checklist generation and management module provides for constructing a custom checklist comprising at least one requirement selected from a standard checklist and at least one requirement not selected from a standard checklist.

11. The system of claim 1, wherein the learning experiences locator finds practice-based learning experiences based at least on geographical region, topic, and medium, wherein a medium is one of an internship, apprenticeship, or part-time job.

12. The system of claim 1, wherein the system is provisioned by a first entity, and the first entity receives compensation for allowing the system to be used by a plurality of educational institutions.

13. The system of claim 1, wherein the system is used by a home school.

14. The system of claim 1, wherein a learning experience is associated with one or more supervisors who are knowledgeable about the particular topic is associated with one of the Boy or Girl Scouts, gap year program, Junior Achievement, or foreign exchange program.

15. The system of claim 1, further comprising a personal mobile device that captures evidence of meeting a requirement by recording a video, audio, photograph, or text and sending the evidence to the evidence documentation module.

16. A method of granting credit by an institution for real-world learning experiences comprising:
defining a learning experience for learning a particular subject matter, wherein the learning experience is not described in a course catalog;
identifying a supervisor to guide the learning experience, the supervisor having experience applying the particular subject matter;
associating an institutional agent with the learning experience, wherein the institutional agent is associated with the institution and is not the supervisor;
generating a list of requirements for successful completion of the learning experience, wherein the list of requirements is based on one or more rubrics or course completion standards;
storing artifacts, wherein each artifact provides evidence of completion for one or more items in the list of requirements;
determining that all requirements are met and determining a quality measure of the evidence;
based on the requirements being met and the quality of the evidence, assigning a score to the learning experience;
translating the score to an amount of credit to award a learner for completion of the real-world learning experience.

17. A collaboration system comprising:
one or more processors communicatively coupled to provide:
a collaboration registry that allows a first person to register interest in collaborating on a particular topic, and allows a second person to find and contact the first person to establish a collaboration on the particular topic; and
a communication platform comprising:
a repository for documents that define checklists based on one or more standard processes that identify action items for the collaboration on the particular topic;
an action item tracking mechanism for:
assigning action items to the first person or the second person;
updating state of one or more action items; and
viewing the state of the collaboration based on the completion of action items; and
an evidence organization module for storing one or more artifacts associated with a particular action item of the collaboration action items. Page 24 of 25
